(19) United States
(12) Patent Application Publication
(10) Pub. No.: US 2017/0291486 A1
(43) Pub. Date: Oct. 12, 2017

(54) HYDROGEN FUEL SUPPLY SYSTEM

(71) Applicant: KAWASAKI JUKOGYO KABUSHIKI KAISHA, Hyogo (JP)

(72) Inventors: Mitsuaki TANAKA, Kobe-shi, Hyogo (JP); Minoru NAKAYASU, Kobe-shi, Hyogo (JP)

(73) Assignee: KAWASAKI JUKOGYO KABUSHIKI KAISHA, Hyogo (JP)

(21) Appl. No.: 15/514,083

(22) PCT Filed: Sep. 16, 2015
(86) PCT No.: PCT/JP2015/004729

§ 371 Date: Mar. 24, 2017

(30) Foreign Application Priority Data
Sep. 26, 2014 (JP) 2014-197411

(51) Int. Cl. B60K 15/01; H01M 8/04746; H01M 8/04007; F02B 43/10; F02M 25/10

(52) U.S. Cl. CPC B60K 15/01; F02B 43/10; F02M 25/10; H01M 8/04007; H01M 8/04776; B60K 2015/03315

(57) ABSTRACT

A hydrogen fuel supply system 1 comprises a tank 2 which stores liquid hydrogen therein; a supply line 4 which takes the liquid hydrogen out of the tank 2, vaporizes the liquid hydrogen into a hydrogen gas, and supplies the hydrogen gas to a use point 3; and a pressurization line 5 which compresses the hydrogen gas generated by vaporization of the liquid hydrogen inside the tank 2 by use of a compressor 59 so that a pressure of the hydrogen gas is increased, and sends the hydrogen gas with the increased pressure to a gaseous phase part inside the tank 2.

### TECHNICAL FIELD

The present invention relates to a hydrogen fuel supply system which supplies liquid hydrogen stored in a tank or the like to a use point as a hydrogen gas.

### BACKGROUND ART

In recent years, the use of a hydrogen gas as fuels of internal combustion engines has been studied. For example, regarding a fuel of a gas turbine engine which is an example of an internal combustion engine, studies have been conducted to utilize hydrogen (by-product hydrogen) produced secondarily in production steps in, for example, petroleum oil, chemical, iron and steel industries, in addition to or instead of a liquefied natural gas (LNG) which is a conventional major fuel.

In a case where hydrogen is used as the fuel as described above, for example, hydrogen is supplied to a use point in a high-pressure gas state of about 2 MPa, in the gas turbine engine. In order to supply the liquid hydrogen stored in the tank to the use point as a high-pressure gas, there are a method in which the liquid hydrogen is vaporized into a hydrogen gas and then a pressure of the hydrogen gas is increased to a predetermined pressure, and a method in which a pressure of the liquid hydrogen is increased, and then the liquid hydrogen is vaporized. Of these two methods, the latter method is more advantageous than the former method in that consumption energy can be reduced.

However, the normal (standard) boiling point of the liquid hydrogen is about −253 degrees C., and the normal melting point of the liquid hydrogen is about −259 degrees C. Thus, the liquid hydrogen is an extremely low temperature (about −259 degrees C. to −253 degrees C. in a normal state pressure) liquid. A pump which can feed such an extremely low temperature liquid with a pressure, can stably perform a continued operation, and can be incorporated in general equipment has not been developed yet. Under the circumstances, as a method which pressurizes the liquid hydrogen without use of the liquid hydrogen pump, a method is proposed, in which the liquid hydrogen inside the tank is pressurized by itself, by taking the liquid hydrogen out of the tank, vaporizing the liquid hydrogen into the hydrogen gas, and then returning the hydrogen gas to the tank.

For example, Patent Literature 1 discloses hydrogen gas supply equipment which comprises a tank which stores the liquid hydrogen therein, a heat exchanger which heats the liquid hydrogen having been taken out of the tank, and a vaporizer which performs heat exchange between the liquid hydrogen to be heated, and air, to vaporize the liquid hydrogen into the hydrogen gas, and supplies the hydrogen gas to the use point. This hydrogen gas supply equipment includes, to pressurize the liquid hydrogen inside the tank, a pressurization line in which the vaporizer vaporizes the liquid hydrogen having been taken out of the tank into the hydrogen gas, the heat exchanger cools the hydrogen gas, and then the hydrogen gas is returned to the tank as a pressurized gas.

### CITATION LIST

### Patent Literature

Patent Literature 1: Japanese-Laid Open Patent Application Publication No. 2009-127813

### SUMMARY OF INVENTION

### Technical Problem

In the configuration disclosed in Patent Literature 1, a pressure increase speed in the inside part of the tank is governed by the vaporization capability of the vaporizer. However, in Patent Literature 1, the hydrogen gas used to pressurize the inside part of the tank is obtained by performing the heat exchange between the liquid hydrogen having been taken out of the tank and the liquid hydrogen to be supplied to the use point. For this reason, in particular, when supply of the fuel starts, relatively long time is taken to increase a pressure in the inside part of the tank to a desired pressure.

In view of the above-described circumstances, the present invention has been developed. An object of the preset invention is to quickly increase a pressure in the inside part of a liquid hydrogen tank without use of a liquid hydrogen pump in a hydrogen fuel supply system which supplies liquid hydrogen stored in a tank to a use point as a hydrogen gas.

### Solution to Problem

A hydrogen fuel supply system of the present invention comprises a tank which stores liquid hydrogen therein; a supply line which takes the liquid hydrogen out of the tank, vaporizes the liquid hydrogen into a hydrogen gas, and supplies the hydrogen gas to a use point; and a pressurization line which compresses the hydrogen gas generated by vaporization of the liquid hydrogen inside the tank so that a pressure of the hydrogen gas is increased, and sends the hydrogen gas with the increased pressure to a gaseous phase part inside the tank.

In accordance with the above-described hydrogen fuel supply system, since the hydrogen gas with the increased pressure is supplied to the inside part of the tank, to pressurize the liquid hydrogen inside the tank, the pressure in the inside part of the tank can be quickly increased without use of a liquid hydrogen pump.

In the above-described hydrogen fuel supply system, the pressurization line may include: a vaporizer which vaporizes the liquid hydrogen having been taken out of the tank into the hydrogen gas, a compressor which increases a pressure of the hydrogen gas, and a heat exchanger which cools the hydrogen gas with the increased pressure. In accordance with the above-described configuration, since the hydrogen gas which has been cooled and has the increased pressure is sent to the gaseous phase part inside the tank, the inside part of the tank can be pressurized while suppressing the vaporization of the liquid hydrogen inside the tank.

In the above-described hydrogen fuel supply system, the heat exchanger may be configured to perform heat exchange between the hydrogen gas with the increased pressure and the liquid hydrogen flowing through the supply line. In accordance with this configuration, since energy used to vaporize the liquid hydrogen flowing through the supply line can be obtained from the hydrogen gas with the increased pressure, energy of the system can be efficiently utilized.

The above-described hydrogen fuel supply system may further comprise a flow rate meter which detects a flow rate of the hydrogen gas generated by vaporization of the liquid hydrogen in the supply line, and a controller which adjusts calories to be supplied from the vaporizer to the liquid hydrogen so that the flow rate of the hydrogen gas which is detected by the flow rate meter reaches a predetermined flow rate. In accordance with this configuration, it becomes possible to adjust the amount of the vaporization of the liquid hydrogen in the pressurization line, to obtain the desired supply amount of the hydrogen gas in the supply line. In addition, the pressure in the inside part of the tank can be quickly increased to a desired pressure.

In the above-described hydrogen fuel supply system, the pressurization line may include a compressor which increases a pressure of a boil off gas of the liquid hydrogen having been taken out of the tank. In accordance with this configuration, since the pressure of the hydrogen gas (boil off gas) having an extremely low temperature, which is generated by naturally vaporizing the liquid hydrogen inside the tank, is increased, and then the hydrogen gas with the increased pressure is returned to the inside part of the tank, the inside part of the tank can be pressurized while suppressing the vaporization of the liquid hydrogen inside the tank.

In the above-described hydrogen fuel supply system, the pressurization line may further include: a buffer tank which temporarily stores therein the boil off gas with the pressure having been increased by the compressor, and a flow rate control valve which controls a flow rate of the boil off gas to be sent from the buffer tank to the inside part of the tank. In accordance with this configuration, by adjusting the amount of the boil off gas with the increased pressure to be sent to the tank, the pressure in the inside part of the tank can be controlled.

In the above-described hydrogen fuel supply system, the pressurization line may further include: a heat exchanger which performs heat exchange between the boil off gas with the pressure having been increased by the compressor and the liquid hydrogen flowing through the supply line. In accordance with this configuration, the boil off gas which has been cooled and has the increased pressure can be sent to the tank.

The above-described hydrogen fuel supply system may further comprise an auxiliary pressurization line which vaporizes the liquid hydrogen having been taken out of the tank into the hydrogen gas and sends the hydrogen gas to the gaseous phase part inside the tank. In this case, the auxiliary pressurization line may include a heat exchanger which performs heat exchange between the boil off gas with the pressure having been increased by the compressor in the pressurization line and the liquid hydrogen in the auxiliary pressurization line. In accordance with this configuration, for example, in a case where a failure occurs in the compressor, or a case where the pressure in the inside part of the tank is still sufficient even after the supply of the boil off gas from the pressurization line, or a case where the pressure in the inside part of the tank is required to be quickly increased, the inside part of the tank can be pressurized by the auxiliary pressurization line.

In the above-described hydrogen fuel supply system, the use point may be, for example, a combustor of a gas turbine engine.

### Advantageous Effects of Invention

In accordance with the present invention, in the hydrogen fuel supply system which supplies the liquid hydrogen stored in the tank to the use point as the hydrogen gas, the hydrogen gas with the increased pressure is supplied to the inside part of the tank, to pressurize the liquid hydrogen inside the tank. Therefore, the pressure in the inside part of the tank can be quickly increased without use of a liquid hydrogen pump.

### BRIEF DESCRIPTION OF DRAWINGS

FIG. 1 is a block diagram showing the schematic configuration of a hydrogen fuel supply system according to Embodiment 1 of the present invention.

FIG. 2 is a block diagram showing the schematic configuration of a hydrogen fuel supply system according to Embodiment 2 of the present invention.

FIG. 3 is a block diagram showing the schematic configuration of a hydrogen fuel supply system according to Modified Example 1 of Embodiment 2 of the present invention.

FIG. 4 is a block diagram showing the schematic configuration of a hydrogen fuel supply system according to Modified Example 2 of Embodiment 2 of the present invention.

FIG. 5 is a block diagram showing the schematic configuration of a hydrogen fuel supply system according to Embodiment 3 of the present invention.

FIG. 6 is a block diagram showing the schematic configuration of a hydrogen fuel supply system according to Modified Example of Embodiment 3 of the present invention.

### DESCRIPTION OF EMBODIMENTS

A hydrogen fuel supply system of the present invention is configured to change liquid hydrogen stored in a tank into a hydrogen gas and supply the hydrogen gas to a use point. The use point is, for example, a combustor (burner) of a hydrogen gas turbine engine which uses hydrogen or a hydrogen-containing gas, as a fuel. Hereinafter, Embodiment 1 to Embodiment 3 will be described with reference to the drawings.

### Embodiment 1

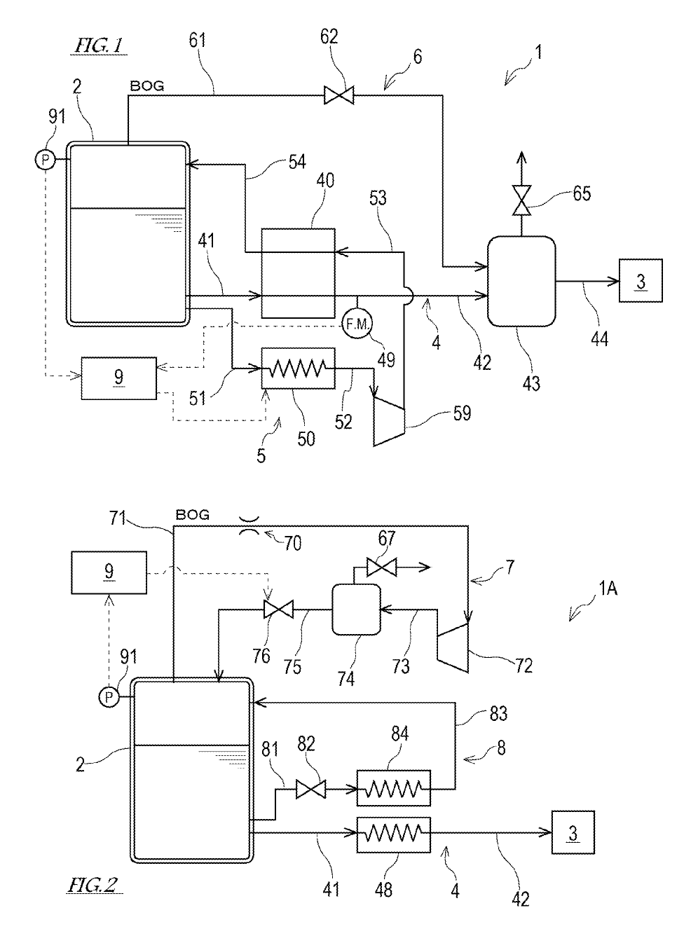

As shown in FIG. 1, a hydrogen fuel supply system 1 according to Embodiment 1 of the present invention includes a tank 2 which stores therein the liquid hydrogen as the fuel, a supply line 4 which supplies the fuel from the tank 2 to a use point 3, a pressurization line 5 which pressurizes the inside part of the tank 2 by vaporizing the liquid hydrogen having been taken out of the tank 2 into a hydrogen gas and returning the hydrogen gas to the tank 2, a BOG line 6 which discharges from the tank 2 the hydrogen gas (BOG: boil off gas) generated by naturally vaporizing the liquid hydrogen inside the tank 2, and a controller 9 which controls the operation of the hydrogen fuel supply system 1.

The supply line 4 is provided with a heat exchanger 40, a pipe 41 connecting the bottom portion of the tank 2 to an inlet (entrance) of the heat exchanger 40, a buffer tank 43, a pipe 42 connecting an outlet (exit) of the heat exchanger 40 to an inlet of the buffer tank 43, and a pipe 44 connecting an outlet of the buffer tank 43 to the use point 3. The heat exchanger 40 performs heat exchange between the liquid hydrogen having been taken out of the bottom portion of the tank 2 and the liquid hydrogen having been compressed by a compressor 59 which will be described later to vaporize the liquid hydrogen having been taken out of the bottom portion of the tank 2. The buffer tank 43 serves to reduce a pressure change in the hydrogen gas to be supplied to the use point 3. The buffer tank 43 is provided with a relief valve 65 which releases the hydrogen gas.

In the supply line 4 having the above-described configuration, the liquid hydrogen having been taken out of the bottom portion of the tank 2 through the pipe 41 is vaporized by the heat exchanger 40, and the vaporized liquid hydrogen (namely, the hydrogen gas) is sent to the buffer tank 43 through the pipe 42. This hydrogen gas is temporarily stored in the buffer tank 43 and then supplied to the use point 3 through the pipe 44.

A BOG pressurization line 7 is provided with a pipe 61 connecting the upper portion of the tank 2 to the inlet of the buffer tank 43, and a flow rate control valve 62 provided in the pipe 61. The “upper portion of the tank 2” refers to a gaseous phase part inside the tank 2.

In the upper portion inside the tank 2, BOG (namely, the hydrogen gas) generated by vaporization of the liquid hydrogen due to external natural heat or the like is accumulated. The BOG is sent to the buffer tank 43 through the pipe 61 by opening the flow rate control valve 62. The BOG is temporarily stored in the buffer tank 43 and then supplied to the use point 3, together with the hydrogen gas having been sent to the buffer tank 43 through the supply line 4. Thus, the BOG line 6 functions as a pressure release line of the tank 2.

The pressurization line 5 is provided with a vaporizer 50, a pipe 51 connecting the bottom portion of the tank 2 to an inlet of the vaporizer 50, the compressor 59, a pipe 52 connecting an outlet of the vaporizer 50 to an inlet of the compressor 59, the heat exchanger 40, a pipe 53 connecting an outlet of the compressor 59 to an inlet of the heat exchanger 40, and a pipe 54 connecting an outlet of the heat exchanger 40 to the upper portion (namely, the gaseous phase part) of the tank 2. Desirably, the compressor 59 capable of compressing the hydrogen gas while maintaining an extremely low temperature state of the hydrogen gas is used.

In the pressurization line 5 having the above-described configuration, the liquid hydrogen having been taken out of the bottom portion of the tank 2 through the pipe 51 is vaporized by the vaporizer 50, and the vaporized liquid hydrogen (namely, the hydrogen gas) is sent to the compressor 59 through the pipe 52. Then, the hydrogen gas is compressed by the compressor 59 and thereby its pressure is increased. Then, the hydrogen gas is sent to the heat exchanger 40 through the pipe 53. Then, the hydrogen gas with the increased pressure is cooled by the heat exchanger 40. The hydrogen gas which has been cooled and has the increased pressure is sent to the upper portion of the tank 2 through the pipe 54. The hydrogen gas which has been cooled, has the increased pressure, and has been returned to the tank 2, pressurizes the liquid hydrogen inside the tank 2.

As described above, the hydrogen gas with the increased pressure is supplied to the inside part of the tank 2, to pressurize the liquid hydrogen inside the tank 2. Therefore, the pressure in inside part of the tank 2 can be quickly increased without use of a liquid hydrogen pump. In addition, since energy used to vaporize the liquid hydrogen sent through the supply line 4 can be obtained from the hydrogen gas with the increased pressure, energy of the system can be efficiently utilized.

The hydrogen gas generated by vaporization of the liquid hydrogen having an extremely low temperature in the vaporizer 50 also has the extremely low temperature (e.g., about −253 degrees C. to −240 degrees C. in a normal state pressure). This hydrogen gas having an extremely low temperature is compressed by the compressor 59 and its temperature is increased to some extent. This hydrogen gas is cooled by the heat exchanger 40 and then returned to the tank 2. Since the hydrogen gas which has been cooled and has the increased pressure is returned to the tank 2 in this way, input of heat into the tank 2 can be suppressed. As a result, the amount of generation of the BOG can be suppressed. It should be noted that the temperature of the hydrogen gas generated by vaporization in the vaporizer 50 is not limited to the extremely low temperature, and the hydrogen gas may be heated by the vaporizer 50 up to a temperature in an allowable temperature range of the compressor 59.

In the pressurization line 5 having the above-described configuration, the vaporizer 50 is desirably a forcible vaporizer including a means which controls the calories to be supplied to the liquid hydrogen. As such a forcible vaporizer, for example, a hot water type vaporizer, a cold water type vaporizer, or a forcible ventilation type vaporizer may be used. In the above case, the pipe 42 through which the hydrogen gas generated by heating and vaporization of the liquid hydrogen in the heat exchanger 40 flows is provided with a flow rate meter 49. The flow rate of the hydrogen gas which is detected by the flow rate meter 49 is output to the controller 9. The tank 2 is provided with a pressure meter 91. A pressure in the inside part of the tank 2 which is detected by the pressure meter 91 is output to the controller 9. Then, the controller 9 controls the calories to be supplied from the vaporizer 50 to the liquid hydrogen based on at least one of the detected flow rate of the hydrogen gas and the detected pressure in the inside part of the tank 2 so that the flow rate of the hydrogen gas flowing through the supply line 4 reaches a predetermined flow rate. In accordance with this configuration, it becomes possible to adjust the amount of the vaporization of the liquid hydrogen in the pressurization line 5, to obtain the desired supply amount of the hydrogen gas in the supply line 4. In addition, compared to a case where a vaporizer of a natural vaporization type is used, the inside part of the tank 2 can be quickly pressurized to a desired pressure, and can be easily maintained at a predetermined pressure (e.g., 2 MPa).

### Embodiment 2

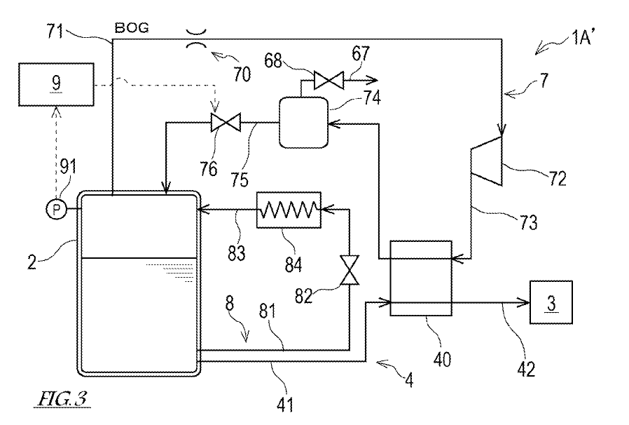

Next, a hydrogen fuel supply system 1A according to Embodiment 2 of the present invention will be described. FIG. 2 is a block diagram showing the schematic configuration of the hydrogen fuel supply system 1A according to Embodiment 2 of the present invention. FIG. 3 is a block diagram showing the schematic configuration of a hydrogen fuel supply system 1A′ according to Modified Example 1 of Embodiment 2 of the present invention. FIG. 3 is a block diagram showing the schematic configuration of a hydrogen fuel supply system 1A″ according to Modified Example 2 of Embodiment 2 of the present invention.

As shown in FIG. 2, the hydrogen fuel supply system 1A includes the tank 2 which stores therein the liquid hydrogen as the fuel, the supply line 4 which supplies the fuel from the tank 2 to the use point 3, a BOG pressurization line 7 which pressurizes the inside part of the tank 2 by taking out of the tank 2 the hydrogen gas (BOG: boil off gas) generated by naturally vaporizing the liquid hydrogen inside the tank 2 into the hydrogen gas and returning the hydrogen gas to the tank 2, an auxiliary pressurization line 8 which pressurizes the inside part of the tank 2 by vaporizing the liquid hydrogen having been taken out of the tank 2 into the hydrogen gas and returning the hydrogen gas to the tank 2, and the controller 9 which controls the operation of the hydrogen fuel supply system 1A.

The supply line 4 is provided with a vaporizer 48, the pipe 41 connecting the bottom portion of the tank 2 to an inlet of the vaporizer 48, and the pipe 42 connecting an outlet of the vaporizer 48 to the use point 3. In the supply line 4 having the above-described configuration, the liquid hydrogen having been taken out of the bottom portion of the tank 2 through the pipe 41 is vaporized by the vaporizer 48, and the vaporized liquid hydrogen (the hydrogen gas) is sent to the use point 3 through the pipe 42.

The BOG pressurization line 7 is provided with a compressor 72, a pipe 71 connecting the upper portion of the tank 2 to an inlet of the compressor 72, a throttle 70 provided at the pipe 71, a buffer tank 74, a pipe 73 connecting an outlet of the compressor 72 to an inlet of the buffer tank 74, a pipe 75 connecting an outlet of the buffer tank 74 to the upper portion of the tank 2, and a flow rate control valve 76 provided in the pipe 75. The buffer tank 74 serves to adjust the amount of the BOG to be returned to the tank 2. The buffer tank 74 is provided with a relief valve 67 which releases the BOG.

In the BOG pressurization line 7 having the above-described configuration, the BOG (namely, the hydrogen gas) accumulated in the upper portion of the tank 2 is sent to the compressor 72 through the pipe 71. The BOG is compressed by the compressor 72 and its pressure is increased. Then, the BOG with the increased pressure is sent to the buffer tank 74 through the pipe 73 and temporarily stored in the buffer tank 74. When the flow rate control valve 76 is opened, the BOG which is stored in the buffer tank 74 and has the increased pressure is supplied to the upper portion of the tank 2 through the pipe 75, and the BOG with the increased pressure pressurizes the liquid hydrogen inside the tank 2. The controller 9 controls the opening degree of the flow rate control valve 76 based on a detection value of the pressure meter 91 to adjust the flow rate of the BOG with the increased pressure which is to be returned to the tank 2 so that the pressure in the inside part of the tank 2 which is detected by the pressure meter 91 reaches a predetermined pressure. In this way, the pressure in the inside part of the tank 2 can be controlled by adjusting the flow rate of the BOG with the increased pressure which is to be sent to the tank 2.

In the present embodiment, the BOG accumulated in the upper portion inside the tank 2 is the hydrogen gas having an extremely low temperature. Since the BOG (hydrogen gas) having the extremely low temperature and has the increased pressure is returned to the tank 2 as described above, input of heat into the tank 2 can be suppressed. As a result, the inside part of the tank 2 can be pressurized while suppressing the vaporization of the liquid hydrogen inside the tank 2. In addition, since the BOG with the pressure having been increased by the compressor 72 is sent to the inside part of the tank 2, the inside part of the liquid hydrogen tank 2 can be quickly pressurized without use of a liquid hydrogen pump.

Alternatively, the BOG with the pressure having been increased by the compressor 72 in the BOG pressurization line 7 may be cooled and then sent to the tank 2. In this case, for example, as shown in FIG. 3, the heat exchanger 40 which performs heat exchange between the liquid hydrogen having been taken out of the tank 2 in the supply line 4 and the BOG with the pressure having been increased by the compressor 72 in the BOG pressurization line 7 may be provided. In the heat exchanger 40, the liquid hydrogen having been taken out of the tank 2 in the supply line 4 is vaporized, and the BOG with the pressure having been pressurized by the compressor 72 in the BOG pressurization line 7 is cooled. In this way, the BOG which has been cooled and has the increased pressure is sent to the inside part of the tank 2, and thus vaporization of the liquid hydrogen inside the tank 2 can be suppressed. Further, since energy used to vaporize the liquid hydrogen having been taken out of the tank 2 can be obtained from the BOG with the pressure having been increased by the compressor 72, the energy can be efficiently utilized.

The auxiliary pressurization line 8 is provided with a vaporizer 84, a pipe 81 connecting the bottom portion of the tank 2 to an inlet of the vaporizer 84, a flow rate control valve 82 provided in the pipe 81, and a pipe 83 connecting an outlet of the vaporizer 84 to the upper portion of the tank 2. In the auxiliary pressurization line 8 having the above-described configuration, for example, in a case where a failure occurs in the compressor 72 or a case where the pressure in the inside part of the tank 2 is still insufficient even after the BOG is supplied from the BOG pressurization line 7, the flow rate control valve 82 is opened. By opening the flow rate control valve 82, the liquid hydrogen having been taken out of the bottom portion of the tank 2 is vaporized by the vaporizer 84 and the vaporized liquid hydrogen (hydrogen gas) is supplied to the upper portion of the tank 2.

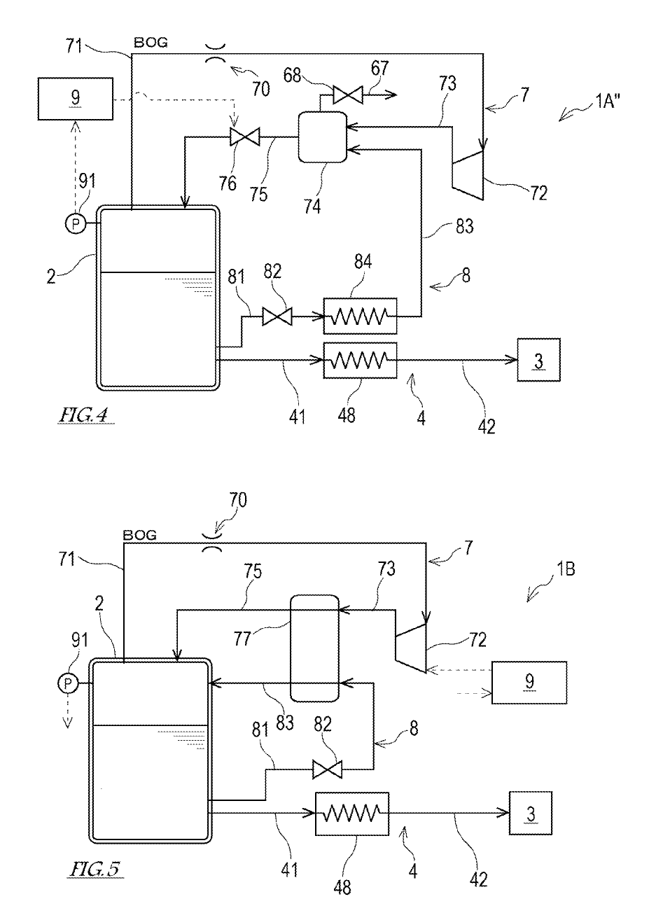

Although in the auxiliary pressurization line 8 having the above-described configuration, the pipe 83 connected to the outlet of the vaporizer 84 is connected to the upper portion of the tank 2, the outlet of the vaporizer 84 and the inlet of the buffer tank 74 may be connected to each other via the pipe 83 as shown in FIG. 4. In this case, the hydrogen gas generated by vaporization in the vaporizer 84 is temporarily stored in the buffer tank 74 and supplied to the upper portion of the tank 2 together with the BOG.

### Embodiment 3

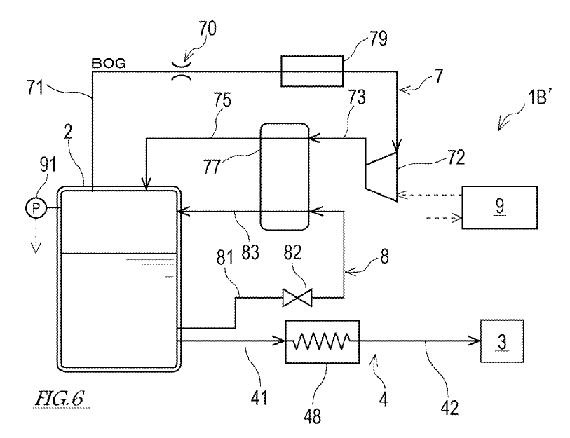

Next, a hydrogen fuel supply system 1B according to Embodiment 3 of the present invention will be described. FIG. 5 is a block diagram showing the schematic configuration of the hydrogen fuel supply system 1B according to Embodiment 3 of the present invention. FIG. 6 is a block diagram showing the schematic configuration of a hydrogen fuel supply system 1B′ according to Modified Example of Embodiment 3 of the present invention.

As shown in FIG. 5, the hydrogen fuel supply system 1B includes the tank 2 which stores therein the liquid hydrogen as the fuel, the supply line 4 which supplies the fuel from the tank 2 to the use point 3, the BOG pressurization line 7 which pressurizes the inside part of the tank 2 by taking out of the tank 2 the hydrogen gas (BOG) generated by naturally vaporizing the liquid hydrogen inside the tank 2 and returning the hydrogen gas to the tank 2, the auxiliary pressurization line 8 which pressurizes the inside part of the tank 2 by vaporizing the liquid hydrogen having been taken out of the tank 2 into the hydrogen gas and returning the hydrogen gas to the tank 2, and the controller 9 which controls the operation of the hydrogen fuel supply system 1B.

The supply line 4 is provided with the vaporizer 48, the pipe 41 connecting the bottom portion of the tank 2 to the inlet of the vaporizer 48, and the pipe 42 connecting the outlet of the vaporizer 48 to the use point 3. In the supply line 4 having the above-described configuration, the liquid hydrogen having been taken out of the bottom portion of the tank 2 through the pipe 41 is vaporized by the vaporizer 48, and the vaporized liquid hydrogen (the hydrogen gas) is sent to the use point 3 through the pipe 42.

The BOG pressurization line 7 is provided with the compressor 72, the pipe 71 connecting the upper portion of the tank 2 to the inlet of the compressor 72, the throttle 70 provided at the pipe 71, a heat exchanger 77, and a pipe 75 connecting an outlet of the heat exchanger 77 to the upper portion of the tank 2. The heat exchanger 77 is configured to perform heat exchange between the BOG and the liquid hydrogen in the auxiliary pressurization line 8 which will be described later. In the heat exchanger 77, the liquid hydrogen in the auxiliary pressurization line 8 is heated and vaporized, and the BOG in the BOG pressurization line 7 is cooled.

In the BOG pressurization line 7 having the above-described configuration, the BOG (namely, the hydrogen gas) accumulated in the upper portion of the tank 2 is sent to the compressor 72 through the pipe 71. The BOG is compressed by the compressor 72 and thereby its pressure is increased. Then, the BOG with the increased pressure is sent to the heat exchanger 77 through the pipe 73 and cooled therein. Then, the BOG which has been cooled and has the increased pressure is supplied to the upper portion of the tank 2 through the pipe 75. The BOG with the increased pressure pressurizes the liquid hydrogen inside the tank 2. The controller 9 controls the rotational speed of the compressor 72 based on a detection value of the pressure meter 91 attached on the tank 2 to adjust the flow rate of the BOG with the increased pressure which is to be returned to the tank 2 so that a pressure in the inside part of the tank 2 which is detected by the pressure meter 91 reaches a predetermined pressure.

In the present embodiment, the BOG accumulated in the upper portion of the tank 2 is the hydrogen gas having an extremely low temperature. Since the BOG (the hydrogen gas) having the extremely low temperature and the increased pressure is returned to the tank 2, as described above, input of heat into the tank 2 can be suppressed. As a result, the inside part of the tank 2 can be pressurized while suppressing the vaporization of the liquid hydrogen inside the tank 2. In addition, since the BOG with the pressure having been increased by the compressor 72 is sent to the tank 2, the inside part of the liquid hydrogen tank can be quickly pressurized without use of a liquid hydrogen pump.

In a case where the temperature of the BOG is lower than a rated temperature range of the compressor 72, as shown in FIG. 6, the pipe 71 connecting the upper portion of the tank 2 to the inlet of the compressor 72 may be provided with a heater 79 to heat the BOG, up to a value in the rated temperature range of the compressor 72, before the BOG is sent to the compressor 72. Further, according to Embodiment 2 as described above, the pipe 75 may be provided with the buffer tank which stores therein the BOG which has been cooled and compressed, and the flow rate control valve.

The auxiliary pressurization line 8 is provided with a heat exchanger 77, the pipe 81 connecting the bottom portion of the tank 2 to an inlet of the heat exchanger 77, the flow rate control valve 82 provided in the pipe 81, and the pipe 83 connecting an outlet of the heat exchanger 77 to the upper portion of the tank 2. In the auxiliary pressurization line 8 having the above-described configuration, for example, when the supply of the fuel starts, the flow rate control valve 82 is opened. By opening the flow rate control valve 82, the liquid hydrogen having been taken out of the bottom portion of the tank 2 is heated and vaporized by the heat exchanger 77, and the vaporized liquid hydrogen (hydrogen gas) is supplied to the upper portion of the tank 2. In this way, for example, when the supply of the fuel starts, the hydrogen gas is sent to the tank 2 through the auxiliary pressurization line 8 and the BOG pressurization line 7. This makes it possible to quickly pressurize the inside part of the tank 2 up to a desired pressure.

### REFERENCE SIGNS LIST

1, 1A, 1B hydrogen fuel supply system

2 tank

3 use point

4 supply line

40 heat exchanger

48 vaporizer

49 flow rate meter

5 pressurization line

50 vaporizer

59 compressor

6 BOG line

7 BOG pressurization line

72 compressor

74 buffer tank

76 flow rate control valve

77 heat exchanger

79 heater

8 auxiliary pressurization line

82 flow rate control valve

84 vaporizer

1. A hydrogen fuel supply system comprising:
a tank which stores liquid hydrogen therein;
a supply line which takes the liquid hydrogen out of the tank, vaporizes the liquid hydrogen into a hydrogen gas, and supplies the hydrogen gas to a use point; and
a pressurization line which compresses the hydrogen gas generated by vaporization of the liquid hydrogen inside the tank so that a pressure of the hydrogen gas is increased, and sends the hydrogen gas with the increased pressure to a gaseous phase part inside the tank.

2. The hydrogen fuel supply system according to claim 1,
wherein the pressurization line includes:
a vaporizer which vaporizes the liquid hydrogen having been taken out of the tank into the hydrogen gas;
a compressor which increases the pressure of the hydrogen gas; and
a heat exchanger which cools the hydrogen gas with the increased pressure.

3. The hydrogen fuel supply system according to claim 2,
wherein the heat exchanger is configured to perform heat exchange between the hydrogen gas with the increased pressure and the liquid hydrogen flowing through the supply line.

4. The hydrogen fuel supply system according to claim 2, further comprising:
a flow rate meter which detects a flow rate of the hydrogen gas generated by vaporization in the supply line, and
a controller which adjusts calories to be supplied from the vaporizer to the liquid hydrogen so that a flow rate of the hydrogen gas which is detected by the flow rate meter reaches a predetermined flow rate.

5. The hydrogen fuel supply system according to claim 1,
wherein the pressurization line includes a compressor which increases a pressure of a boil off gas of the liquid hydrogen having been taken out of the tank.

6. The hydrogen fuel supply system according to claim 5,
wherein the pressurization line further includes:
a buffer tank which temporarily stores therein the boil off gas with the pressure having been increased by the compressor, and
a flow rate control valve which controls a flow rate of the boil off gas to be sent from the buffer tank to the inside part of the tank.

7. The hydrogen fuel supply system according to claim 5,
wherein the pressurization line further includes:
a heat exchanger which performs heat exchange between the boil off gas with the pressure having been increased by the compressor and the liquid hydrogen flowing through the supply line.

8. The hydrogen fuel supply system according to claim 5, further comprising:
an auxiliary pressurization line which vaporizes the liquid hydrogen having been taken out of the tank into the hydrogen gas and sends the hydrogen gas to the gaseous phase part inside the tank.

9. The hydrogen fuel supply system according to claim 8,
wherein the auxiliary pressurization line includes a heat exchanger which performs heat exchange between the boil off gas with the pressure having been increased by the compressor in the pressurization line and the liquid hydrogen in the auxiliary pressurization line.

10. The hydrogen fuel supply system according to claim 1,
wherein the use point is a combustor of a gas turbine engine.

11. The hydrogen fuel supply system according to claim 3, further comprising:
a flow rate meter which detects a flow rate of the hydrogen gas generated by vaporization in the supply line, and
a controller which adjusts calories to be supplied from the vaporizer to the liquid hydrogen so that a flow rate of the hydrogen gas which is detected by the flow rate meter reaches a predetermined flow rate.

12. The hydrogen fuel supply system according to claim 6,
wherein the pressurization line further includes:
a heat exchanger which performs heat exchange between the boil off gas with the pressure having been increased by the compressor and the liquid hydrogen flowing through the supply line.

13. The hydrogen fuel supply system according to claim 6, further comprising:
an auxiliary pressurization line which vaporizes the liquid hydrogen having been taken out of the tank into the hydrogen gas and sends the hydrogen gas to the gaseous phase part inside the tank.

14. The hydrogen fuel supply system according to claim 2,
wherein the use point is a combustor of a gas turbine engine.

15. The hydrogen fuel supply system according to claim 3,
wherein the use point is a combustor of a gas turbine engine.
